(19) United States
(12) Patent Application Publication
(10) Pub. No.: US 2008/0019392 A1
(43) Pub. Date: Jan. 24, 2008

(54) APPARATUS AND METHOD FOR CONTROLLING HOME CONTROL NETWORK

(75) Inventor: Hyeon-jae LEE, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/779,524

(22) Filed: Jul. 18, 2007

(30) Foreign Application Priority Data
Jul. 18, 2006 (KR) 10-2006-0067109

(51) Int. Cl. H04J 3/22

(52) U.S. Cl. 370/467; 370/466

(57) ABSTRACT

Provided are an apparatus and method for controlling a plurality of controlled devices in a first home control network employing various topologies in a second home network. The apparatus which has a first interface unit which supports a first protocol for controlling one or more controlled devices in a first home control network, includes a second interface unit supporting a second control protocol used in a second home network, and a control unit having a proxy which allows the controller to operate as a virtual second home network device representing the controlled devices by performing protocol conversion between the first and second interface units.

### CROSS-REFERENCE TO RELATED PATENT APPLICATIONS

This application claims the benefit of Korean Patent Application No. 10-2006-0067109, filed on Jul. 18, 2006, in the Korean Intellectual Property Office, the disclosure of which is incorporated herein in its entirety by reference.

### BACKGROUND OF THE INVENTION

1. Field of the Invention

The present invention relates to home networking, and more particularly, to an apparatus and method for controlling a plurality of controlled devices in a first home control network subject to various topologies in a second home network.

2. Description of the Related Art

As home networking has been developing, various models of home control (home automation) networks in a household have been commercialized. A home control network consists of a plurality of controlled devices and one controller that is a home pad, and allows the controlled devices to be controlled by exchanging commands between each of the controlled devices and the controller. The network topology of such a home control network consists of interfaces and communication protocols based on unique techniques of each device developer. The controller communicates with each controlled device by giving the controlled device a unique command according to each topology, and each controlled device includes physical interfaces and a protocol stack matching the topology in order to understand the given command.

FIG. 1 is a diagram illustrating a conventional, power line type home control network topology. Referring to FIG. 1, various protocols, such as Lonwork and Homeplug, are used. For example, under the Lonwork topology of power line type communication, all controlled devices 110 include a power line modem therein, and have additional devices, such as a central processing unit (CPU), memory, and an operating system (OS), for driving a related protocol stack so as to understand a Lonwork protocol. These additional devices allow the controlled devices 110 to communicate with a controller 100.

FIG. 2 is a diagram illustrating a conventional, dedicated line type home control network topology. Referring to FIG. 2, each of controlled devices 210 is connected to a controller 200 via a dedicated line such as RS-232.

FIG. 3 is a diagram illustrating a conventional home control network topology employing a dedicated line point-to-point method. Referring to FIG. 3, a controller 300 includes physical interfaces, the total number of which is equal to the total number of controlled devices 310 in order to establish a one-to-one communication with each of the controlled devices 310.

As described above, there are home control networks having various topologies, the logical operating manner of which has a response construction in which each controlled device responds to a command given from a controller. Although various mechanisms may exist according to the degree of implementation or the complexity of each technique, the mechanisms may be generalized as follows. First, a user selects a controlled device that is to be controlled, via a display of a controller. In general, a monitor and a touch screen user interface (UI) are used in order to select a desired controlled device. After clicking a menu of the selected controlled device, the user selects a desired item from among a plurality of items of the menu that represent the controlled device by using the UI. Then, if the user sets the characteristic value of the controlled device as desired, the controller transmits control data to the selected controlled device via a physical interface. The controlled device receiving the control data performs an operation according to the command, and transmits the result of performing the operation to the controller in response to the command data. Then, the result of performing the operation is displayed on the display of the controller so that it can be fed back to the user.

However, a controlled device subject to only one topology is not compatible with another controlled subject to a different topology. Nowadays, there are so many standards and techniques that are to be applied between each controlled device and a controller in a household, and thus compatibility problems between devices have reached a crisis. For example, it is impossible to control a water supply gauge or a gas gauge by using a home pad purchased to control an air conditioner and electric lamps. Such incompatibility prevents home control technologies from being extremely interoperable. Accordingly, home builders who desire to build home network-based residence have determined a home control network and installed only devices matching the determined network before building, thereby degrading the generality and compatibility of the network. For this reason, business model development of home control networking has mainly been initiated by home builders, and therefore, the growth of home network industries have been checked due to high prices of incompatible devices.

Also, since a home pad for home control networking is installed in only a region of a house, a user must move to the region in order to operate a controlled device, thereby significantly degrading the movability and convenience of home networking.

In order to solve the above problems, the standards for home networking, such as digital living network alliance (DLNA), which allows all devices in a home network to be interactively controlled have been suggested. However, actually, it is impossible to install a protocol stack of a new home network to interactively operate with the existing controlled devices (an air conditioner, light lamps, a gas sensor, a gauge sensor, etc.) in a home control network, in terms of costs.

### SUMMARY OF THE INVENTION

The present invention provides an apparatus and method for allowing a device in a second home network to control a plurality of controlled devices in a first home control network by interconnecting the second home network to the home control network while minimizing additional costs.

According to an aspect of the present invention, there is provided a controller having a first interface unit which supports a first protocol for controlling one or more controlled devices in a first home control network, the controller including a second interface unit supporting a second control protocol used in a second home network, and a control unit having a proxy which allows the controller to operate as a virtual second home network device representing the controlled devices by performing protocol conversion between the first and second interface units.

The proxy may create a description document describing the types and functions of the controlled devices, and the control unit may output the description document via the second interface unit.

The proxy may transform a control message according to the second control protocol received via the second interface unit into a control command according to the first control protocol, and the control unit may transmit the control command to a controlled device that is to be controlled from among the controlled devices, via the first interface unit.

The proxy may receive a response to the control command via the first interface unit and then transform the response into a response message according to the second control protocol. The control unit may transmit the response message to a second home network device which has transmitted the control message, via the second interface unit.

The proxy may transform a first event message received via the first interface unit into a second event message according to the second control protocol, and the control unit may output the second event message via the second interface unit.

The proxy may include an XML (extensible markup language) document transform unit which transforms data received via the first interface unit into a markup document which is understandable to a device in the second home network.

The proxy may include a user interface transform unit which transforms a user interface allowing the controller to control the controlled devices into a markup document to be displayed on a device in the second home network.

According to another aspect of the present invention, there is provided a method of interactively operating a controller, which has a first interface unit supporting a first protocol for controlling one or more controlled devices in a first home control network and a second interface unit supporting a second control protocol, with a second home network using the second control protocol, the method including creating a description document describing the types and functions of the controlled devices and then transmitting the description document to the second home network via the second interface unit; transforming first data received via the second interface unit into second data according to the first control protocol and then transmitting the second data to a desired controlled device from among the controlled devices via the first interface unit; and transforming third data received via the first interface unit into fourth data according to the second control protocol and then transmitting the fourth data to the second home network via the second interface unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional, power line type home control network topology;

FIG. 2 is a diagram illustrating a conventional, dedicated line type home control network topology;

FIG. 3 is a diagram illustrating a conventional home control network topology employing a dedicated line point-to-point method;

FIG. 4 is a diagram illustrating a construction in which a first home control network and a second home network operate interactively, according to an exemplary embodiment of the present invention;

FIG. 5 is a block diagram of a home control network controller according to an exemplary embodiment of the present invention;

FIG. 6 is a block diagram of a home control network controller according to another exemplary embodiment of the present invention; and

FIG. 7 is a flowchart illustrating a method of controlling a home control network according to an exemplary embodiment of the present invention.

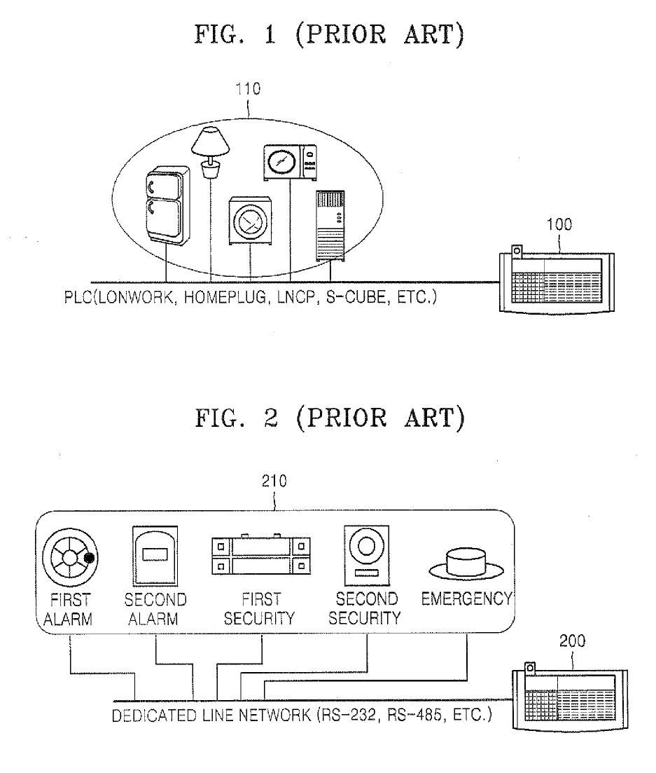

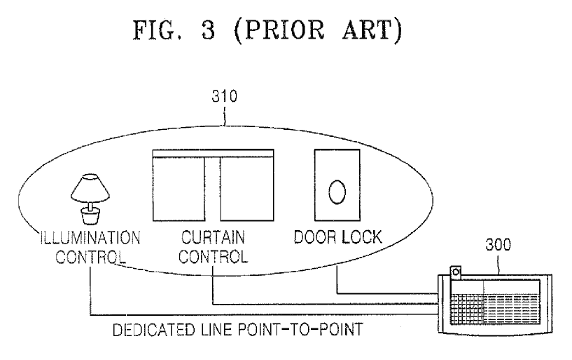

### DETAILED DESCRIPTION OF THE INVENTION

Exemplary embodiments of the present invention will now be described more fully with reference to the accompanying drawings.

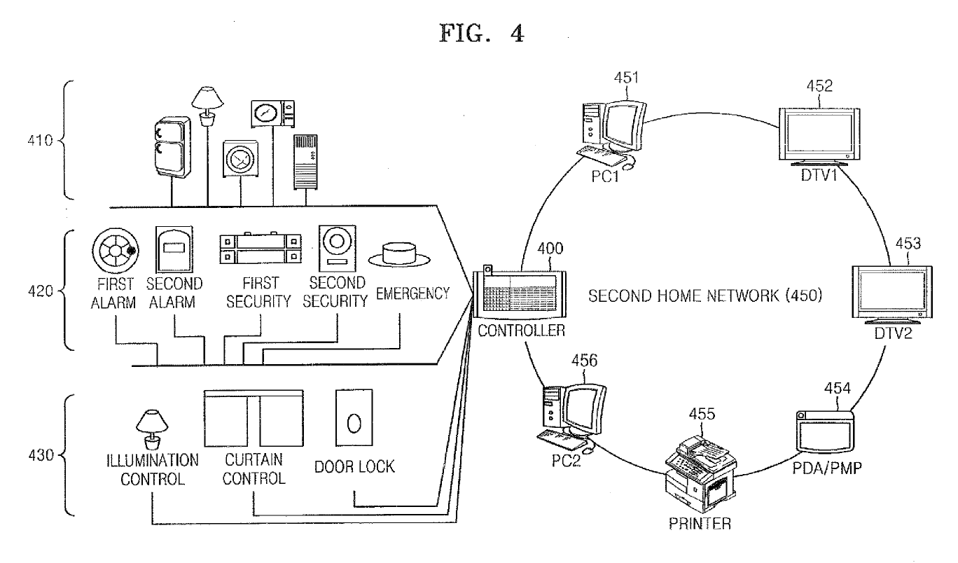

FIG. 4 is a diagram illustrating a construction in which a first home control network and a second home network operate interactively, according to an embodiment of the present invention. Referring to FIG. 4, a controller 400 that acts as a home pad for one of a plurality of home control networks 410, 420 and 430, performs protocol conversion between a control protocol employed in a first home control network 410, 420, or 430 that the controller 400 controls and a second control protocol employed in a second home network 450. Thus, the controller 400 acts as a virtual second home network device that represents a plurality of controlled devices in the first home control network 410, 420 or 430, in terms of the second home network 450. Consequently, a plurality of devices 451 through 456 belonging to the second home network 450 can control the controlled devices in the first home control network 410, 420 or 430, via the controller 400. FIG. 4 illustrates the controller 400 (home pad device) that controls the home control network 410 that is a power line type network, the home control network 420 that is a dedicated line type network and/or the home control network 430 that is a dedicated line point-to-point type network, but the present invention is not limited thereto. That is, the present invention can be applied to any type of home control network without respect to an employed control protocol. The controlled devices that constitute a home control network and the controller 400 (home pad device) are physically connected using a conventional method and also use a conventional logical protocol. Also, the second home network 450 is not limited to a network having a particular topology.

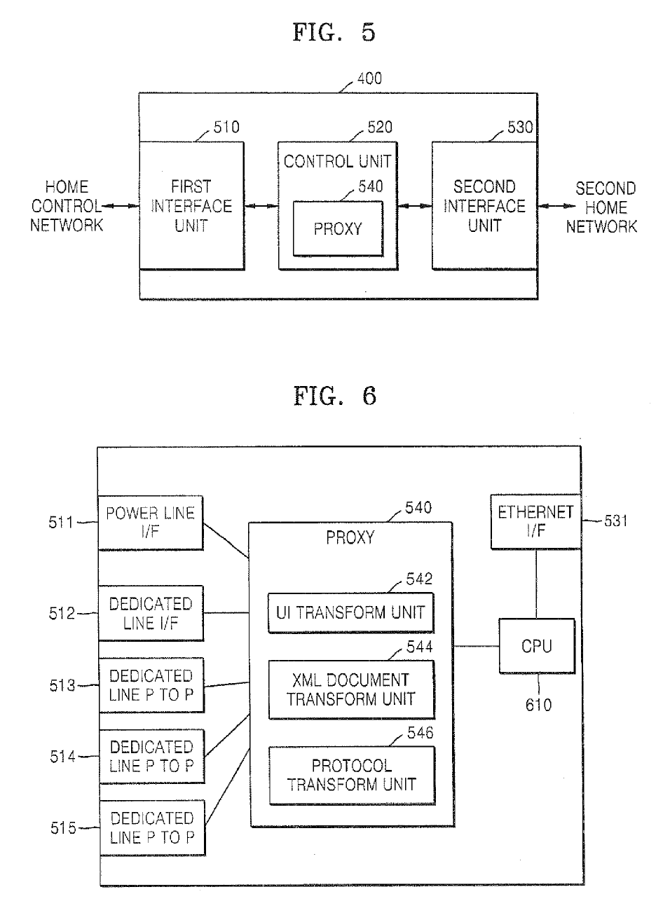

FIG. 5 is a block diagram of the controller 400, illustrated in FIG. 4, of a home control network, according to an embodiment of the present invention. Referring to FIG. 5, the controller 400 is a home pad device having a first interface unit 510 that supports a protocol for controlling a plurality of controlled devices in a first home control network. The controller 400 also includes a control unit 520 that drives a proxy 540 in order that the first home control network can operate interactively with a second home network, and second interface unit 530 that supports a protocol for communicating with the second home network. Here, the first interface unit 510 and the second interface unit 530 are used as definitions including both a physical interface and a protocol stack. The first interface unit 510 supports a unique control protocol of the first home control network, and the second interface unit 530 includes a protocol stack and a physical interface, such as an Ethernet interface, needed for the controller 400 to act as a device in the second home network. The proxy 540 performs protocol conversion between the first interface unit 510 and the second interface unit so that the controller 400 can operate as a virtual second home network device that represents all controlled devices.

FIG. 6 is a block diagram illustrating the internal construction of the controller 400, illustrated FIG. 5, in a first home control network according to an embodiment of the present invention. Referring to FIG. 6, the controller 400 includes as first interface units a plurality of interfaces 511 through 515 for interfacing with one or more home control networks, and thus can understand various communication methods available with controlled devices (not shown) in the one or more home control networks and control the controlled devices using the methods. In order that the controller 400 can operate interactively with a second home network, the proxy 540 transforms control data, content, and data for user interfacing, received from the controlled device via the interface 511, 512, 513, 514 or 515, into data according to a second control protocol; and data received from a second home network device (not shown) via an Ethernet interface 531 into data according to a unique control protocol between the controlled device and the controller 400. A control unit 520 of the controller 400 includes a central processing unit (CPU) 610 for operating the proxy 540. An operating system (OS) (not shown) for driving an application program for protocol interpretation is further included in the control device 400. Also, the controller 400 needs to additionally have as a second interface unit the Ethernet interface 531 for allowing the controller 400 to operate interactively with the second home network. However, in the case of most of home pads that have currently been distributed, a CPU of 1 GHz or higher is mounted, Windows OS or Linux OS is installed for executing an application program, and further, an Ethernet interface is basically included for access to the Internet. Accordingly, only a module, such as the proxy 540 according to the present invention, needs to be further added to a home pad, and thus, significant additional costs are not incurred.

The control unit 520 creates a description document describing the types and functions of controlled devices via the proxy 540 and then transmits the description document to the second home network in order to provide the second home network with the control mechanism of controlled devices in the first home control network managed by the controller 400 as a home pad. The description document may consist of a device description XML document and a service description XML document according to UPnP specifications. Then a controller in the second home network can detect the presence of the controller 400 as a device in the second home network by parsing the description document.

The following is an example of a device description document according to the present invention. In the example, the uniform resource locators (URLs) of service descriptions are linked in a <SCPDURL> element. Also, the URL of the opposite party device to which a command is to be input using “HTTP PUT” is described in a <controlURL> element. The URL of the opposite party device which is to subscribe to an event by using “HTTP Notify” is described in an <eventSubURL> element.

<?xml version=“1.0”?>
<root xmlns=“urn:schemas-upnp-org:device-1-0”>

<specVersion>

<major>1</major>
<minor>0</minor>

</specVersion>
<URLBase>base URL for all relative URLs</URLBase>
<device>

<deviceType>urn:schemas-upnp-org:device:deviceType:v</deviceType>
<friendlyName>short user-friendly title</friendlyName>
<manufacturer>manufacturer name</manufacturer>
<manufacturerURL>URL to manufacturer site</manufacturerURL>
<modelDescription>long user-friendly title</modelDescription>
<modelName>model name</modelName>
<modelNumber>model number</modelNumber>
<modelURL>URL to model site</modelURL>
<serialNumber>manufacturer's serial number</serialNumber>
<UDN>uuid:UUID</UDN>
<UPC>Universal Product Code</UPC>
<iconList>

<icon>

<mimetype>image/format</mimetype>
<width>horizontal pixels</width>
<height>vertical pixels</height>
<depth>color depth</depth>
<url>URL to icon</url>

</icon>
XML to declare other icons, if any, go here

</iconList>
<serviceList>

<service>

<serviceType>urn:schemas-upnp-org:service:serviceType:v</serviceType>
<serviceId>urn:upnp-org:serviceId:serviceID</serviceId>'
<SCPDURL>URL to service description</SCPDURL>
<controlURL>URL for control</controlURL>
<eventSubURL>URL for eventing</eventSubURL>

</service>
Declarations for other services defined by a UPnP Forum WC (if any) go here
Declarations for other services added by UPnP vendor (if any) go here

</serviceList>
<deviceList>

Description of embedded devices defined by a UPnP Forum WC (if any) go here
Description of embedded devices added by UPnP vendor (if any) go here

</deviceList>
<presentationURL>URL for presentation</presentationURL>

</device>

</root>

An example of a service description document is as follows:

<?xml version=“1.0”?>
<scpd xmlns=“urn:schemas-upnp-org:service-1-0”>

<specVersion>

<major>1</major>
<minor>0</minor>

</specVersion>
<actionList>

<action>

<name>actionName</name>
<argumentList>

<argument>

<name>formalParameterName</name>
<direction>in xor out</direction>
<retval/>
<relatedStateVariable>stateVariableName</relatedStateVariable>

</argument>

Declarations for other arguments defined by UPnP Forum WC (if any)go here
</argumentList>

</action>
Declarations for other actions defined by UPnP Forum WC (if any)go here
Declarations for other actions added by UPnP vendor (if any) go here

</actionList>
<serviceStateTable>

<stateVariable sendEvents=“yes”>

<name>variableName</name>
<dataType>variable data type</dataType>
<defaultValue>default value</defaultValue>
<allowedValueList>

<allowedValue>enumerated value</allowedValue>
Other allowed values defined by UPnP Forum WC (if any) go here

</allowedValueList>

</stateVariable>
<stateVariable sendEvents=“yes”>

<name>variableName</name>
<dataType>variable data type</dataType>
<defaultValue>default value</defaultValue>
<allowedValueRange>

<minimum>minimum value</minimum>
<maximum>maximum value</maximum>
<step>increment value</step>

</allowedValueRange>

</stateVariable>
Declarations for other state variables defined by UPnP Forum WC(if any) go here
Declarations for other state variables added by UPnP vendor (if any) go here

</serviceStateTable>

</scpd>

Then, the controller 400 is registered with the second home network as a proxy device that represents the first home control network, and the devices in the second home network that desire to control the controlled devices can be connected to the controller 400 by using the second control protocol used in the second home network controller. In this case, each of the devices in the second home network acts as a control point (CP) for controlling the first home control network, and the controller (home pad) 400 is registered as a second home network device to be controlled. The devices in the second home network can detect the presence of the devices connected to the first home control network and monitor the states of the detected devices, via the controller 400. In order to enable a second home network device to control a controlled device in the first home control network, the second home network device may transmit a control message for requesting a desired service described in the description document. For example, the second home network device may transmit a simple object access protocol (SOAP) message in an XML format to the controller 400 in order to give a command that a desired controlled device should be controlled. When receiving the control message, the control unit 520 transforms via the proxy 540 the control message into a control command according to a unique protocol for controlling the controlled device and then transmits the control command to the controlled device. In response to the control command received from the controller 400, the controlled device performs the control command and transmits the result of performing the control command to the controller 400. The controller 400 receiving the result of performing the control command transforms it into a response message, e.g., a SOAP response message, according to the second control protocol and then transmits the response message to the second home network device that transmitted the control message.

Assuming that the controlled devices can generate an event according to a state change, the controller 400 receives a first event message from a controlled device, transforms the event message into a second event message according to the second control protocol, e.g., a general event notification architecture (GENA) message in an XML format, and then transmits the second event message to the second home network in order to notify the state change in the controlled device. In the same way, it is possible to appropriately perform temperature control by checking the temperature of an air conditioner via not only a digital television (DTV) in a living room but also a notebook computer in a library.

The proxy 540 may embodied to include a plurality of modules such as a protocol transform unit 546 for protocol transformation, an XML document transformation unit 544 that transforms data received via the Ethernet interface 531 into a markup document that a second home network device communicating with the controller 400 can understand, and a user interface transformation unit 542 that transforms a user interface, which allows the controller 400 to control a controlled device, into a markup document that is to be displayed on the second home network device.

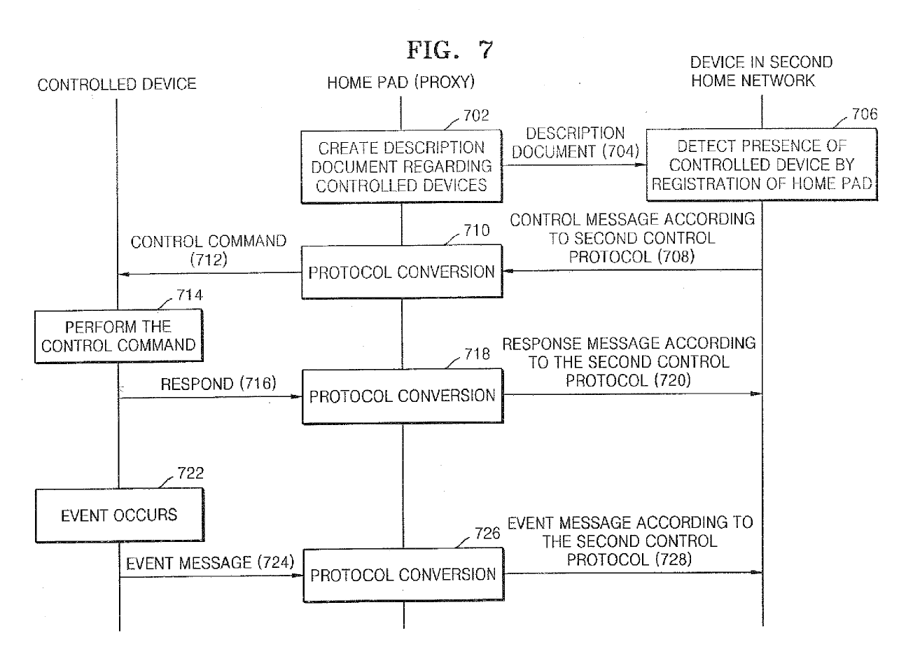

FIG. 7 is a flowchart illustrating a method of controlling a home control network according to an embodiment of the present invention. Referring to FIG. 7, a proxy of a home pad first creates a description document regarding a plurality of controlled devices in a first home control network and then transmits it to a second home network (operations 702 and 704). Next, devices in the second home network register the home pad as a new second home network device in order to detect the presence of controlled devices managed by the home pad (operation 706). A user of a second home network device can indirectly control a desired controlled device from among the controlled devices via the home pad by selecting a desired service from among services described in the description document and then transmitting a control message (operation 708). Then, the proxy interprets the received control message in order to identify the desired controlled device and then transforms the control message into a control command in a format matching the desired controlled device (operation 710). If the desired controlled device receives the control command (operation 712), it performs the control command (operation 714) and then transmits the result of performing the control command to the home pad (operation 716). The proxy transforms the result of performing the control command into a response message according to a second control protocol (operation 718) and then transmits the response message to the second home network device that transmitted the control message (operation 720). If a state change in the desired controlled device leads to occurrence of an event (operation 722), the proxy transforms a first event message into a second event message according to the second control protocol and then transmits the second event message to the second home network device (operations 724 through 728)

The above method according to the present invention can be embodied as computer readable code in a computer readable medium.

As described above, according to exemplary embodiments of the present invention, it is possible to control a home control network employing conventional, various protocols in another home network without incurring significant additional costs.

Also, home control can be conveniently performed without respect to place since it is possible to control devices in a home control network by using any device in a house.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A controller having a first interface unit which supports a first protocol for controlling one or more controlled devices in a first home control network, the controller comprising:
a second interface unit which supports second control protocol used in a second home network; and
a control unit having a proxy which allows the controller to operate as a virtual second home network device representing the controlled devices by performing protocol conversion between the first and second interface units.

2. The controller of claim 1, wherein the proxy creates a description document describing types and functions of the controlled devices, and
the control unit outputs the description document via the second interface unit.

3. The controller of claim 1, wherein the proxy transforms a control message according to the second control protocol received via the second interface unit into a control command according to the first control protocol, and
the control unit transmits the control command to a controlled device that is to be controlled from among the controlled devices, via the first interface unit.

4. The controller of claim 3, wherein the proxy receives a response to the control command via the first interface unit and then transforms the response into a response message according to the second control protocol, and
the control unit transmits the response message to a second home network device which has transmitted the control message, via the second interface unit.

5. The controller of claim 1, wherein the proxy transforms a first event message received via the first interface unit into a second event message according to the second control protocol, and
the control unit outputs the second event message via the second interface unit.

6. The controller of claim 1, wherein the proxy comprises an XML (extensible markup language) document transform unit which transforms data received via the first interface unit into a markup document which is understandable to a device in the second home network.

7. The controller of claim 1, wherein the proxy comprises a user interface transform unit which transforms a user interface allowing the controller to control the controlled devices into a markup document to be displayed on a device in the second home network.

8. A method of interactively operating a controller, which has a first interface unit supporting a first protocol for controlling one or more controlled devices in a first home control network and a second interface unit supporting a second control protocol, with a second home network using the second control protocol, the method comprising:
creating a description document describing types and functions of the controlled devices and then transmitting the description document to the second home network via the second interface unit;
transforming first data received via the second interface unit into second data according to the first control protocol and then transmitting the second data to a desired controlled device from among the controlled devices via the first interface unit; and
transforming third data received via the first interface unit into fourth data according to the second control protocol and then transmitting the fourth data to the second home network via the second interface unit.

9. The method of claim 8, wherein the transforming of the first data and the transmitting of the second data comprises:
receiving a control message according to the second control protocol via the second interface unit and then transforming the control message into a control command according to the first control protocol; and
transmitting the control command to the desired controlled device via the first interface unit.

10. The method of claim 9, wherein the transforming of the third data and the transmitting of the fourth data comprises:
receiving a response to the control command via the first interface unit and then transforming the response into a response message according to the second control protocol; and
transmitting the response message to a device in the second home network, which has transmitted the control message, via the second interface unit.

11. The method of claim 8, wherein the transforming of the third data and transmitting of the fourth data comprises:
receiving a first event message via the first interface unit and then transforming the first event message into a second event message according to the second control protocol; and
outputting the second event message via the second interface unit.

12. The method of claim 8, further comprising:
transforming a user interface, which allows the controller to control the controlled devices into a markup document to be displayed on the device in the second home network; and
outputting the markup document via the second interface unit.

13. A computer readable medium having recorded thereon a program for executing a method of interactively operating a controller, which has a first interface unit supporting a first protocol for controlling one or more controlled devices in a first home control network and a second interface unit supporting a second control protocol, with a second home network using the second control protocol, the method comprising:
creating a description document describing types and functions of the controlled devices and then transmitting the description document to the second home network via the second interface unit; and
transforming first data received via the second interface unit into second data according to the first control protocol and then transmitting the second data to a desired controlled device from among the controlled devices via the first interface unit; and
transforming third data received via the first interface unit into fourth data according to the second control protocol and then transmitting the fourth data to the second home network via the second interface unit.

14. The computer readable medium of claim 13, wherein the transforming of the first data and transmitting of the second data comprises:
receiving a control message according to the second control protocol via the second interface unit and then transforming the control message into a control command according to the first control protocol; and
transmitting the control command to the desired controlled device via the first interface unit.

15. The computer readable medium of claim 13, wherein the transforming of the third data and transmitting of the fourth data comprises:
receiving a response to the control command via the first interface unit and then transforming the response into a response message according to the second control protocol; and
transmitting the response message to a device in the second home network, which has transmitted the control message, via the second interface unit.
